(19) United States
(12) Patent Application Publication
(10) Pub. No.: US 2010/0106977 A1
(43) Pub. Date: Apr. 29, 2010

(54) Method and Apparatus for Secure Software Platform Access

(76) Inventors: Jan Patrik Persson, Lund (SE); Johan Eker, Lund (SE); Bjorn Johansson, Lund (SE)

Correspondence Address: COATS & BENNETT, PLLC, 1400 Crescent Green, Suite 300, Cary, NC, 27518, US

(21) Appl. No.: 12/266,810

(22) Filed: Nov. 7, 2008

Related U.S. Application Data
(60) Provisional application No. 61/108,108, filed on Oct. 24, 2008.

(51) Int. Cl. H04L 9/06; G06F 21/22

(52) U.S. Cl. 713/189; 726/30

(57) ABSTRACT

In an advantageous approach to securing type safety in software platform accesses made by software applications, this disclosure teaches the inclusion of cryptographically signed type information in software applications, for authentication and registration by a software platform. With this approach, a given software application is permitted to make platform accesses (e.g., data type instantiations, memory accesses, method invocations, etc.) only in conformance with the registered type information.

### RELATED APPLICATIONS

This application claims priority under 35 U.S.C. §119(e) from the U.S. Provisional Patent Application Ser. No. 61/108,108, which was filed on 24 Oct. 2008, and entitled “Method and Apparatus for Secure Software Platform Access.”

### TECHNICAL FIELD

The present invention generally relates to distributed software, and particularly relates to securing software platform accesses made by distributed software components.

### BACKGROUND

Software platforms may be based on language/architecture implementations that include sophisticated type checking and safety provisions, to guard against malicious or erroneous platform accesses made by software applications installed on or otherwise running in conjunction with the software platform. On the other hand, some software platforms, particularly those used to drive real-time systems in embedded applications (like mobile communication devices and other handheld instruments) may be based on the C-language or another lower-level language, for the attendant performance and size advantages of such languages. Generally, however, such languages have no built in type safety, meaning that it is difficult to protect against malicious or erroneous platform accesses.

One approach is to allow only completely trusted applications to make accesses to the memory space and functions provided by the software platform, but this approach prevents or at least complicates the desire to allow device users to buy new software applications, many of which require or would benefit from having access to security-sensitive elements of the software platform.

To understand these security issues, it may be noted that traditional distributed software component systems (e.g., DCOM or ERICSSON's “DECM”) allow components in one memory space to access functionality implemented by components in other memory spaces. In essence, such systems are object-oriented (or component-oriented) versions of remote procedure calls (RPC). A method invocation is performed by passing a message from the caller to the callee. Upon method invocation, all method parameters are serialized (marshaled) and included in the invocation message. The parameters are de-serialized (un-marshaled) by the callee, which then performs the actual invocation.

Remote access to software platform resources requires the accessing applications to make calls or to otherwise pass messages to the software platform. For security-sensitive platforms, these accesses must be restricted to valid memory locations. An untrusted application cannot be allowed to make arbitrary accesses to the platform's memory space, nor can it be allowed to invoke security-sensitive methods. Indeed, full platform access may be restricted to trusted (i.e., signed) applications. However, signing applications is cumbersome. Thus, it may not be worthwhile to undergo the burden of creating and distributing a given software application as a signed application, even though the functionality of the software application would be enhanced if it could gain secure access to the software platform to which it is targeted.

Moreover, even for signed applications, several access levels may be desirable (e.g., trusted third-party developers, operators, device manufacturers). These situations require mechanisms within the software platform to verify that an application accesses only a selected subset of platform resources. For example, the trust level of a given software application may be used to determine which ones of the software platform's Application Program Interfaces (APIs) are available to the given software application. Such mechanisms, e.g., making run-time decisions on whether to allow a given platform access or not, are generally referred to as access control mechanisms.

Known access control mechanisms relate to type safety verification for data and for methods. That is, control mechanisms can be used to ensure that memory accesses to the platform's memory space are restricted to valid types, and that the access parameters (sizes, pointers, etc.) are all in conformance. Doing so prevents malicious or mistaken memory reads/writes, overruns, etc. Similar type safety checks can be performed for platform methods invoked by software applications.

Traditional component systems address these problems by serialization of objects. However, serialization (in the caller)/de-serialization (in the callee) is undesirable since it is interface-specific. For each method that is to be remotely accessible, dedicated code must de-serialize the parameters. This implies a high “footprint” overhead because, for each platform method in each platform API that is to be exposed to software applications, FLASH or other non-volatile memory will be consumed. This implies a memory cost for each accessible platform method, regardless of whether it is actually invoked or not. The approach also implies potentially excessive caller-callee communication because all referenced data involved in an invocation must be serialized upon all invocations. If the same heap data is involved in several invocations, it will be completely serialized each time.

### SUMMARY

In an advantageous approach to securing type safety in software platform accesses made by software applications, this disclosure teaches the inclusion of cryptographically signed type information in software applications, for authentication and registration by a software platform. With this approach, a given software application is permitted to make platform accesses (e.g., data type instantiations, memory accesses, method invocations, etc.) only in conformance with the registered type information. One advantage of this approach is the reduction in the amount of memory needed by the software platform for type safety processing, as only those data and method types actually used by the given application need be registered and accounted for. Another advantage is that including type information in software applications allows distributed software applications to be safely installed and executed, even on secure software platforms, such as those typically implemented in mobile communication devices.

In one embodiment, in a software platform, a method of securing accesses made to the software platform by a software application includes receiving cryptographically signed type information from the software application, for platform accesses to be made by the software application. The method further includes determining whether a cryptographic signature of the received type information is authentic, and, if so, registering the type information in the software platform. Correspondingly, the method further includes permitting platform accesses by a software application that comport with the registered type information. As non-limiting examples, the software application registers the (heap space) data types it will use and the platform methods it will invoke, and any subsequent run-time data instantiations, memory accesses, and method invocations by the software application are permitted only if they comport with the registered type information.

In another embodiment, a programmed computer implements a software platform that secures accesses made to the software platform by a software application. The software platform includes an application program interface (API) layer and an access control layer functionally disposed as an intermediary between the API layer and software applications making use of the API layer. The access control layer enforces type safety by being configured to receive cryptographically signed type information from the software application for platform accesses to be made by the software application, and determine whether a cryptographic signature of the received type information is authentic. If the cryptographic signature is authentic, the access control layer registers the type information and permits platform accesses by the software application that comport with the registered type information. As an advantageous example, the software platform is a closed, secured, or otherwise restricted platform, and accesses by a given software application are permitted only to the extent that such accesses comport with type information cryptographically authenticated and registered for that given software application.

In one or more embodiments, the software platform comprises a mobile communication device software platform, and the programmed computer comprises a mobile communication device processor, which may have secure memory, etc. In such embodiments, the software platform “secures” accesses made to the platform by software applications, e.g., downloaded widgets, applets, components, etc., by permitting platform accesses that comport with the type information registered for each such application. Here, the term “secures” means, inter alia, to make safe.

In another embodiment, a method of generating a software application intended to gain secure access to a software platform comprises generating type information describing software platform data types and methods to be used by the software application, and cryptographically signing the type information using cryptographic key data known to or compatible with decryption processing in the software platform. The method further includes embedding or otherwise bundling the cryptographically signed type information with the software application. Still further, the method includes configuring the software application to provide the cryptographically signed type information to the software platform for verification by the software platform, .e.g., at run-time, to thereby gain access to software platform data types and methods as identified in the cryptographically signed type information.

In yet another embodiment, a method for a software application to gain secure access to a software platform comprises, upon initial execution or loading of the software application, sending cryptographically signed type information to the software platform and receiving registration information for registered data and method types. Here, the cryptographically signed type information identifies those platform data and method types to be used by the software application, and the method further includes using the registration information during execution of the software application to generate requests to the platform for data type instantiations, memory accesses, and method invocations. In one such embodiment, the registration information comprises links or pointers to heap space data memory maintained by the software platform.

However, the present invention is not limited to the above summary of features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is block diagram of one embodiment of callee software and caller software, which may be a software platform and a software application, respectively.

FIG. 2 is a block diagram of one embodiment of a wireless communication device and a supporting wireless communication network, where the device includes a software platform.

FIG. 3 is a logic flow diagram for one embodiment of a method of a software platform registering type information for a software application.

FIG. 4 is a block diagram of one embodiment of a programmed computer having a software platform in trusted memory space and a software application in untrusted memory space.

FIG. 5 is a block diagram of one embodiment of a system for generating cryptographically signed type information for embedding in software applications.

FIGS. 6A and 6B are diagrams of different embodiments for including a reference from an allocated heap instance to the corresponding heaptype.

FIG. 7 is a diagram of the results of a heap instance allocation in one embodiment.

### DETAILED DESCRIPTION

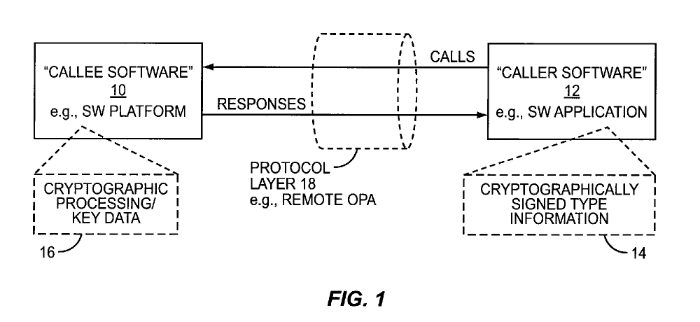

FIG. 1 illustrates one embodiment of “callee” software 10 and “caller” software 12, wherein the callee software 10 provides memory and program resources that can be used by the caller software 12, subject to security restrictions. Rather than requiring that the caller software 12 be a completely trusted application, the callee software 10 receives cryptographically signed type information 14 from the caller software 12, which provides type information for all accesses to be made by the caller software 12.

The callee software 10 includes cryptographic processing resources (e.g., decryption processing functions) and cryptographic key data 16, which it uses for determining whether the cryptographic signature is authentic. If the cryptographic signature is authentic, meaning that the type information was generated by a trusted party, the callee software 10 registers the type information and verifies run-time accesses made by the caller software 12 to the callee software 10, according to the registered type information 14. In one example embodiment, the callee software 10 is a “software platform” and the caller software 12 is a “software application.”

For ease of discussion, therefore, the balance of this disclosure will refer to the callee software 10 as the software platform 10 and will refer to the caller software 12 as the software application 12. As used in this context, the term “software platform” denotes inter alia an operating system for a computer system, but more broadly denotes any software application that serves in some sense as a base or foundation for other software applications. In at least one embodiment, the software platform 10 provides an Application Program Interface (API) that allows the software application 12 to make defined function calls, including calling data and return data, all in accordance with the registered type information. Correspondingly, in one or more embodiments, the software application 12 is a distributed software application (e.g., a downloadable program, applet, module, component, etc.) that makes calls to the software platform 10 and receives corresponding responses in return.

Communications between the software platform 10 and the software application 12 may take place through a protocol layer 18, which may be implemented in complementary fashion by the platform 10 and the application 12. In one non-limiting example, the protocol layer 18 is an “OPEN MOBILE ALLIANCE” (OMA) protocol supporting remote accesses to the software platform 10 by one or more software applications 12—OMA is a well known industry consortium of networking, communication, and content-provider companies.

In particular, remote OPA (rOPA for short) is a software component technology that is specially designed for running a software platform (with OPA) in one address space and running software applications in another address (memory) space. Remote OPA retains a master copy of all (OPA-related) heap data within the platform's memory space, and method invocations by software applications in rOPA do not contain serialized heap data. Instead, these method invocations include pointers to the heap data in the platform's memory space. While rOPA is based on “jOPA” (Java-based OPA), it is not specifically concerned with any particular application language. Of further note, jOPA uses a security solution for type/method safety that is based on Java virtual machine security, and thus differs from the type/method registration security solution contemplated herein.

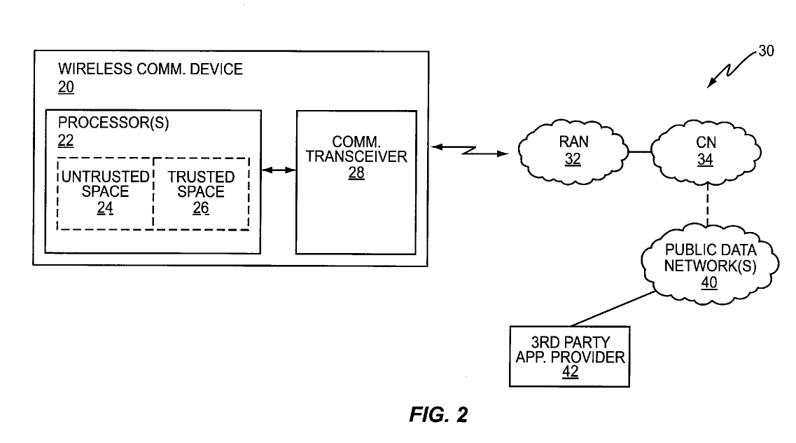

Independent of whether a rOPA protocol interface is used between the software platform 10 and the software application 12, the software platform 10 may comprise a software platform for a wireless communication device. FIG. 2 illustrates one embodiment of a wireless communication device 20 that comprises one or more processors 22 implementing an untrusted memory space 24 and a trusted memory space 26. The processor(s) 22 comprise, for example, one or more microprocessors and supporting data and program memory. The software platform 10 is implemented within the trusted memory space 26 and provides software applications running in the untrusted memory space 24 with access to low-level platform functions subject to security restrictions. For example, the software platform 10 may allow completely trusted software applications—e.g., applications pre-installed and controlled by the device vendor—direct access to communication functions supported by the device's communication transceiver 28.

However, the user experience of the device owner is enhanced by allowing the user to install and run software applications, in addition to any preinstalled applications. For example, the wireless communication device 20 is configured to communicate with a wireless communication network 30 (including a Radio Access Network or RAN 32 and a Core Network or CN 34) that communicatively couples the device 20 to one or more Public Data Networks (PDNs) 40. In at least one embodiment, the PDN(s) 40 provide access to a software application database 42, from which the device 20 can download software applications. The PDN(s) 40 may include or couple to the Internet and the database 42 may comprise a web server that provides access to games, business software, or essentially any type of distributed, downloadable software application.

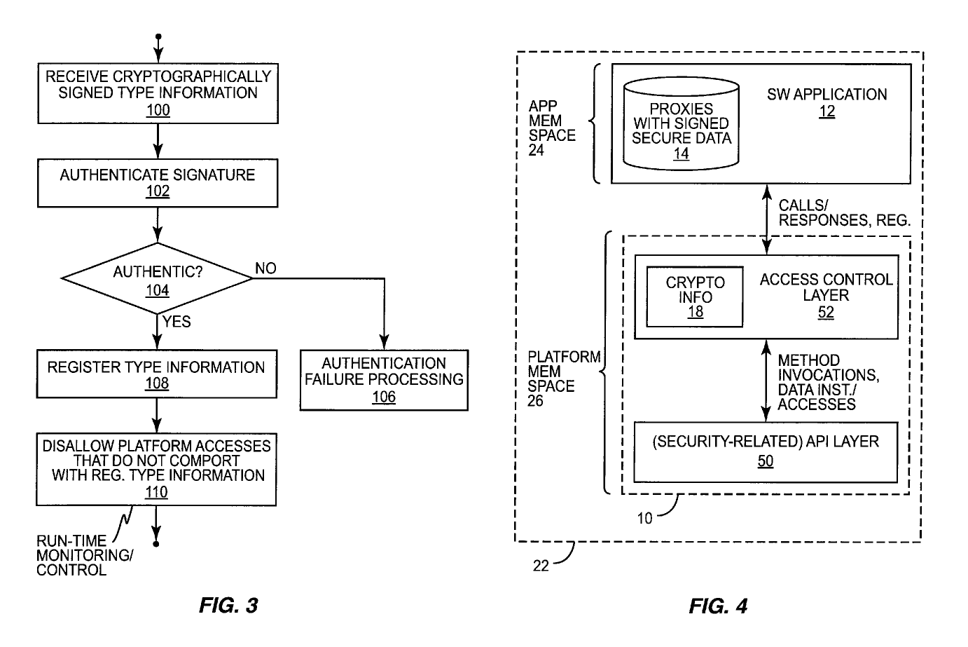

Trusted type information is embedded or otherwise included in such applications, allowing the software platform 10 of device 20 to perform run-time verification of platform accesses (memory, function/method invocations, etc.). Such processing is illustrated in FIG. 3, which depicts one embodiment of a method of securing accesses made to the software platform 10 by a software application 12. The illustrated method is implemented in one or more embodiments of the software platform 10, and it should be understood that at least some steps of the illustrated processing may be performed in another sequence, or concurrently, or looped/repeated, and that such processing may be part of an overall set of processing tasks. For example, with respect to the wireless communication device 20 of FIG. 2, the software platform 10, including the illustrated method, may be implemented by the processor(s) 22 executing stored computer program instructions stored in memory or other computer readable media included in or accessible to the processor(s) 22.

Assuming that the software platform 10 is running and that a given software application 12 has been loaded or otherwise initiated for execution, the illustrated method comprises receiving cryptographically signed type information from the software application 12, for platform accesses to be made by the software application 12 (Block 100). That is, at load time or otherwise upon initiation of the software application 12, the software application 12 is configured to send cryptographically signed type information to the software platform 10. Receipt and verification of such information are prerequisites to allowing the software application 12 to run or otherwise access the software platform 10.

Thus, the method continues with the software platform 10 determining whether a cryptographic signature of the received type information is authentic (Block 102). If the cryptographic signature is not authentic, or for some reason fails verification (No from Block 104), the software platform 10 carries out authentication failure processing (Block 106). That processing includes, for example, disallowing any operations or further execution of the software application 12, generating diagnostic/alert information, e.g., for a user.

If the cryptographic signature is authentic (Yes from Block 104), the method continues with registering the type information in the software platform 10 (Block 108), and permitting platform accesses by the software application 12 that comport with the registered type information (Block 110). This last “step” or operation can be understood as an ongoing or continuous process running for the duration of execution of the software application 12, to ensure that its accesses to the software platform 10 comport with the registered type information. Here, an access that “comports” with registered type information can be understood as an access whose type and parameters all match, fit, or otherwise conform to the type information cryptographically authenticated and registered for the particular software application 12.

As for understanding these access restrictions, in at least one embodiment, receiving cryptographically signed type information from the software application 12, for platform accesses to be made by the software application 12, comprises receiving signed data type information and signed method type information. That is, the software application 12 must register the data types it will use, and must register the methods that it will call or otherwise invoke, including an identification of the calling and return argument types involved in those invocations. Thus, determining whether the cryptographic signature of the received type information is authentic includes the software platform 10 verifying one or more cryptographic signatures for the data type information and one or more cryptographic signatures for the method type information. In this regard, it should be understood that each data type to be used, and each method to be invoked may include a separate cryptographic signature—e.g., a data type or method type dependent cryptographic hash using secret key data known to the software platform 10.

In a further example, receiving cryptographically signed type information from the software application 12, for platform accesses to be made by the software application 12, comprises the software platform 10 receiving one or more heap data type registration messages. The message(s) include cryptographically signed heap data type registration information for use by the software platform in registering heap data types that will be used by the software application 12. The software platform 10 correspondingly is configured to return one or more heap data type “handles” (pointers or other identifiers) to the software application 12, for referencing registered heap data types. During run-time execution of the software application 12, the software platform 10 uses the registered heap data types for verifying instantiations requested by the software application 12 of heap data types, and for verifying platform memory accesses by the software application 12 to instances of those heap data types.

Still further, in at least one embodiment, the software platform 10 receives one or more method type registration messages as part of the type information received from the software application 12. Such received information includes cryptographically signed method type registration information for use by the software platform 10 in registering method types to be invoked by the software application 12. Correspondingly, the software platform 10 is configured to return one or more method type handles to the software application 12, for referencing registered method types (in run-time method invocations).

Thus, registering the type information in the software platform 10 comprises, in such embodiments, registering the data type information and registering the method type information to yield registered data type information and registered method type information, respectively. Further, in at least one such embodiment, registering the method type information includes verifying that each method type being registered links only to registered data types. Thus, the platform 10 first authenticates the data type information and registers it, and then authenticates the method type information and registers it, if the method type information is consistent with the registered data type information.

The registration process thus can be understood as the software platform 10 registering the data and method types to be used by the software application 12, in advance of allowing the software 12 to make platform accesses. With that understanding, Block 110 in FIG. 3 can be understood as permitting platform method invocations and platform memory accesses by the software application 12 that match the registered method or data type information. Conversely, particularly where the software platform 10 is a secure or otherwise closed platform, such as might be used in a mobile communication device, any platform method invocation or platform memory access that does not comport with registered type information is disallowed. In such embodiments, only accesses to the software platform 10 by the software application 12 that do comport with the registered type information are permitted, which is consistent with the underlying premise that the type information for the software application 12 was authenticated as being trusted.

In that regard, verifying the cryptographic signature of the type information presented by the software application 12 is, as was mentioned, based on cryptographic key information 16 securely maintained by the software platform 10. The cryptographic key information 16 comprises, for example, the same key can be used in a symmetric key algorithm or a Public Key Infrastructure, PKI, cryptographic key data solution can be adopted. The software platform 10 would then have to contain both a public key (to verify signatures in received type information) and a private key (to generate run-time signatures for pointers or other registration information returned to the software application 12 as part of the registration process).

Note, too, that the same key and hashing functions can be used to sign both data type information and method type information. On the other hand, one key can be used for signing data type information, and another key can be used for signing heap allocation, method invocation, or other type information. Similarly, different hash functions can be used.

In any case, the author or vendor of the software application 12 has access to the same secret key data as is stored in the software platform 10, or is part of the same PKI of public/private key pairs, and can therefore generate legitimately signed type information for the software application 12. Alternatively, a given party may retain strict control of such key data, given its sensitivity, but makes legitimately signed type data available to software vendors that are trusted by that given party, thereby allowing those vendors to build their applications with signed type data included in them.

The above-described software platform method embodiments and variations of those embodiments can be implemented in the example embodiment of device 20 illustrated in FIG. 4. For example, the processor(s) 22 of the device 20 (including program and data memory) may be understood as a programmed computer that is configured or otherwise operated in accordance with the instructions making up the software platform 10.

In this context, one sees that the software application 12 resides in the untrusted memory space 24 of the device 20, while the software platform 10 resides in the trusted memory space 26 of the device 20. (The device 20 may include an ARM TRUSTZONE environment or other secure environment, as one example of the trusted memory space 26, and the trusted memory space 26 includes heap memory for maintaining the heap data used in carrying out API functions (methods) called by the software application 12.)

The programmed computer described here thus implements a software platform 10 that secures accesses made to the software platform 10 by a software application 12, where the software platform 10 comprises an application program interface (API) layer 50 and an access control layer 52. The access control layer 52 is functionally disposed as an intermediary between the API layer 50 and the software application 12 making use of the API layer 50. (The access control layer 52 acts as a functional intermediary between the API layer 50 and any number of software applications running in the untrusted memory space 24, providing data and method type safety and verification for run-time operations of those applications.)

In this role, the access control layer 52 is configured to receive cryptographically signed type information from the software application 12, for platform accesses to be made by the software application 12, and to determine whether a cryptographic signature of the received type information is authentic. The access control layer 52 registers the type information in the software platform 10 if the cryptographic signature is authentic, and thereafter permits platform accesses by the software application 12 that comport with the registered type information. Conversely, accesses that do not comport with the type information registered for the software application 12 are disallowed. Those skilled in the art will appreciate that the software platform 10, and particularly the access control layer 52, can be configured according to the processing of FIG. 3 and any of the further details elaborated earlier herein for such processing.

Of course, the software application 12 must directly support such processing, by providing the cryptographically signed type information for verification by the software platform 10. Correspondingly, one method of generating a software application 12 that is intended to gain secure access to a software platform 10 comprises generating type information describing software platform data types and methods to be used by the software application 12, and cryptographically signing the type information using cryptographic key data known to or compatible with decryption processing in the software platform 10. The method further includes embedding or otherwise bundling the cryptographically signed type information with the software application 12. These method operations can be understood as relating to the “building” of the software application 12, i.e., these steps are part of creating the software application 12 in advance of distributing it.

As noted, program code in the software application 12 is also included, to configure the software application 12 to provide the cryptographically signed type information to the software platform 10 for verification by the software platform 10, to thereby gain access to software platform data types and methods as identified in the cryptographically signed type information. Accordingly, a method for the software application 12 to gain secure access to the software platform 10 comprises, upon initial execution or loading of the software application 12 (by the software platform 10), sending cryptographically signed type information to the software platform 10 and receiving registration information for registered data and method types. That is, the software platform 10 returns registration information to the software application 12 for the data and method type information it submitted for registration, and the software application 12 correspondingly uses that registration information during execution of the software application 12, to generate requests to the platform 10 for data type instantiations, memory accesses, and method invocations. As noted, the registration information returned by the software platform 10 in one or more embodiments comprises links or pointers to heap space data memory maintained by the software platform 10.

Referring to FIG. 4, one sees that the cryptographically signed type information 14 is embodied as a set of proxies that include signed, secure type data for the software application 12. The use of such proxies to carry the cryptographically signed type information 14 provides for a particularly advantageous but non-limiting approach to embedding trusted type information into distributable software applications.

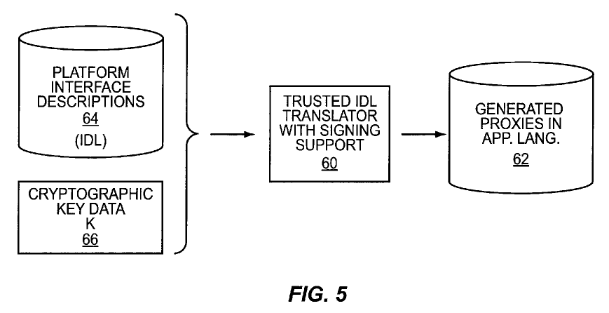

In particular, FIG. 5 illustrates a method of generating proxies with signed secure type data. A specially designed Interface Description Language (IDL) translator 60 translates IDL files into proxies 62 for the desired application language (the particular language used for the software application 12). The IDL translator 60 generates the proxies 62 based on the data types and methods available within a given, targeted software platform 10, which are captured in the IDL-based platform interface descriptions 64. The IDL translator 60 also has access to cryptographic key data 66, which is the same as or relates to the cryptographic key data 16 maintained in the targeted software platform 10. As such, the generated proxies 62 are cryptographically signed in a manner that can be later authenticated by the targeted software platform(s) 10.

The proxies 62 thus carry data and method type information available within the platform 10, and therefore can be used to build a software application 12 with correctly signed type information. Note that the cryptographically signed type information 14 carried within the software application 12 (as shown in FIG. 1) may comprise only a relevant subset of the proxies 62. “Relevant” here means the subset of data and method types that are used by the software application 12, and thus need to be registered with the software platform 10, to enable the software application 12 to carry out security-related operations on the software platform 10.

Creating an instance of heap data within the trusted memory space of the software platform 10 represents one example of a security-sensitive operation, and provides a good basis for further discussion. To securely create a heap data instance and use that in a method invocation, the following example steps are involved: (1) the software application 12 registers heap data type information with the software platform 10; and (2) registers method type information with the software platform 10. Correspondingly, the software platform 10 allocates heap data instances as needed, for the software application 12 to perform memory accesses (to heap data instances), and to perform method invocations (e.g., to make API function calls). Processing on the software platform side generally extends to de-allocating heap data and de-register method and heap data type information, as appropriate (e.g., upon termination of the software application 12).

A hypothetical platform method can be used as a running example. For example, one may use a method denoted as “IClock::SetTime”, as described in ERICSSON's IDL, which is defined as follows:

```
...
interface IClock ...
{
  ...
  RVoid SetTime( [in] TTime* pTime);
  ...
}
```

The struct type TTime is defined as follows (FUint8 is an unsigned 8-bit integer type):

```
typedef struct {
  FUint8 Hours;
  FUint8 Minutes;
  FUint8 Seconds;
  TDate *pDate;
} TTime;
```

The PDate element points to an instance of TDate, defined as follows:

```
typedef struct {
  FUint16 Year;
  FUint8 Month;
  FUint8 Day;
} TDate;
```

The software application 12 therefore is responsible for allocating a TDate and a TTime instance, populating them with the correct time, and passing a pointer to the populated TTime instance in the invocation of SetTime( ). Correspondingly, the software platform 10 must perform run-time verification that, upon IClock::SetTime( )invocation, the parameter pTime points to a valid TTime instance (or has the special value NULL). Further, the software platform 10 must verify that, upon write access to a TTime type instance, the pDate element value points to a valid TDate instance (or is NULL).

These run-time verifications by the software platform 10 of course depend on proper registration of data and method type information prior to or at the outset of execution for the software application 12. In a detailed example, the software application 12 is configured first to register heap data type information with the software platform 10. The software application 12, e.g., upon being loaded into the untrusted memory space 24 shown in FIG. 4, sends heap type information to the software platform 10 that is sufficient for allowing the software platform 10 to verify subsequent run-time instantiations of heap data types by the software application 12, and memory access by the software application 12 to those instances.

The data type information (referred to from here on as “heaptype”) provided to the software platform 10 by the software application 12 as part of this initial registration comprises, for example, the size of the data type, in bytes; a set of pairs, one for each pointer-valued member in the type, including the offset (in bytes) of the member within the type and a reference to the heaptype describing the referenced value. For a leaf data type (i.e., a type containing no further references), the set of pointer members is empty.

While the actual data structure used in a real-world software application 12 will vary, an example data structure for the clock time example is given as:

heaptype_{TDate} = <4, { }>, and
heaptype_{TTime} = <8, {<4, heaptype_{TDate}>}>.

These examples assume pointers to be 32 bits in size and stored on even 32-bit boundaries. Such constraints are specific to the device platform (of the software platform 10) (e.g., ARM, x86, . . . ) and thus are known at IDL translation time.

In any case, the type information registration can be performed by sending a message from the software application 12 to the software platform 10 in the following form:

REGISTER_HEAPTYPE(size, N, offset₁, heaptype₁, offset_{N}, heaptype_{N}, S_{heaptype}).

In response, the software platform 10 returns a heaptype handle to the software application 12 that references the registered heaptype. (This may be implemented as a simple pointer to the type information and the signature, or in some other way.) The signature S_{heaptype} is computed (e.g., by the IDL translator 60 in FIG. 5) as

```
S_{heaptype} = f_{sign}(K, size, N,
  offset₁, S_{heaptype}_{_{—}}₁, ..., and
  offset_{N}, S_{heaptype}_{_{—}}_{N}),
```

where heaptypeᵢ are heaptype handles obtained by the software application 12 successfully registering the referenced heaptypes with the software platform 10. With this embodiment, then, a given heaptype cannot be registered until all heaptypes referenced by it have been installed.

The signature can then be verified at run-time by the software platform 10, upon receiving the REGISTER_HEAPTYPE message. The returned heaptype reference can be verified upon later use by verifying the signature of the referenced type information.

Once the software application 12 registers the data type information as above, method type information can be registered. The purpose of method type registration is to provide the software platform 10 with sufficient information to perform run-time verification of the integrity of method invocation calls made to the software platform 10 by the software application 12.

Continuing the example from above within the ERICSSON OPA platform and ERICSSON IDL contexts, the type information consists of these items: a “UUID,” which is a 128-bit interface identity uniquely identifying the interface, e.g., identifying the IClock interface; a method index comprising an integer that uniquely identifies the method within the interface; a type descriptor for each of the parameters; and a signature for verification. Note that the type descriptor for a heap data type is the heaptype. Also, note that the term ‘parameters’ here refers to the raw sequence of 32-bit values involved in a method invocation (the stack contents). Each method parameter is represented by one such 32-bit value (or, for 64-bit types, two values).

In one embodiment, the type information registration is performed by sending a message from the software application 12 to the software platform 10 in the following form:

REGISTER_METHODTYPE(UUID, index, N, arg_descr₁, arg_descr_{N}, S_{method}),

where S_{method} is a signature computed (by the IDL translator 60 in FIG. 5) as

S_{method}=f(K, UUID, index, N, S_{heaptype1}, . . . , S_{heaptypeN}).

The use of signatures S_{heaptypeX} here implies that the method parameters are heap pointers. The signature for scalar data types could be represented by a placeholder, e.g., 0.), and “K” will be understood to the cryptographic key data 66 shown in FIG. 5, which is the same as that used in the software platform 10 for signature verification, or is otherwise securely related to that used in the software platform 10 for signature verification. The function ƒ is a hash function with suitable cryptographic properties, for example, and the integer N indicates the number of 32-bit values in the argument list.

Upon the software platform 10 receiving the above message from the software application 12, it returns a corresponding reference to the software application 12 (assuming successful signature verification by the software platform 10). In an advantageously simple implementation, the software platform 10 stores the contents of the REGISTER_METHODTYPE message in the trusted memory space 26, and returns a pointer to that location. Of course, other implementations may be used and, in any case, once the type information is registered, the method can be invoked by the software application 12 an arbitrary number of times. Therefore, this registration step only needs to be performed by the software application 12 once (typically at application start or proxy load time).

With the above registrations successfully completed, the software platform 10 allocates heap data instances as needed to support requests by the software application 12 during its run-time operations, at least to the extent that those requests comport with the registered type information. In a particular example, allocating a heap data instance is performed by passing a message from the software application 12 to the software platform 10 in the following form:

HEAP_ALLOC(heaptype),

where heaptype identifies a valid, previously registered heaptype. The allocated heap data instance includes a reference to the heaptype, stored outside of the memory area allocated to the actual heap data instance. In one embodiment, the reference is stored immediately before the instance, and in another embodiment the reference is stored immediately after the instance.

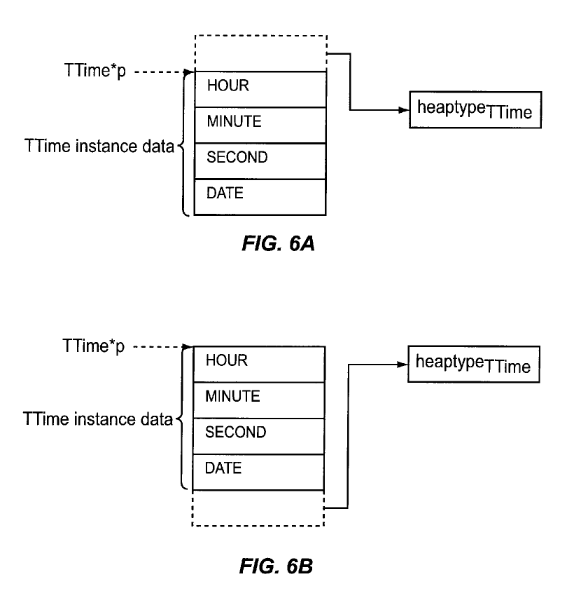

In any case, the software platform 10 verifies that the indicated heaptype reference is valid (by verifying its signature), and returns a pointer to the allocated memory to the software application 12. A newly allocated heap instance has well-defined initial values for its components; in particular, all pointers assume the value NULL. FIGS. 6A and 6B depict allocation examples using the above clock-related example context. Particularly, FIG. 6A depicts an example of a signed pointer for a TTime instance, where the reference is stored immediately before the instance. FIG. 6B depicts a TTime instance, where the reference is stored immediately after the instance.

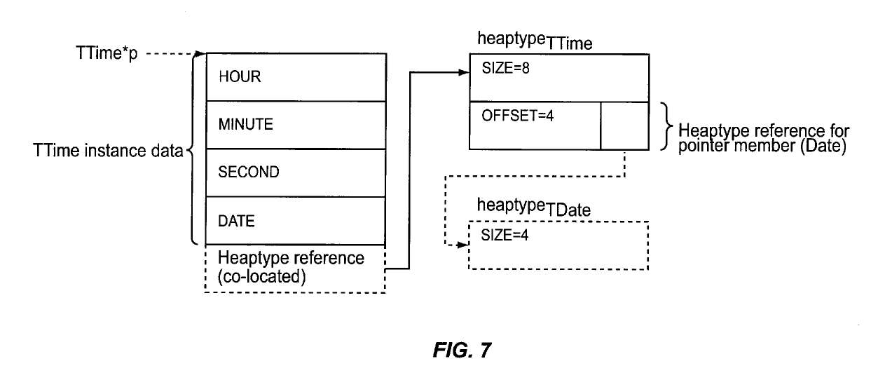

In a related example, FIG. 7 depicts the results of a heap instance allocation of a TTime structure. In particular, FIG. 7 illustrates a TTime heap instance in (platform) memory, co-located with a reference to the TTime heaptype. In turn, the TTime heaptype references the TDate type.

Further example details relate to memory reads and writes by the software application 12 from/to the memory space of the software platform 10. A specific example is given for a memory write operation, and those skilled in the art will appreciate that similar operations apply to memory reads. A memory write access to an allocated heap data instance is performed by passing a message from the software application 12 to the software platform 10 in the following form:

HEAP_WRITE(p, heaptype, offset, data),

where p is the pointer value obtained from the HEAP_ALLOC operation, heaptype is the heaptype used for allocation, offset is the relative position within the heap element to write to, and data is a set of bytes to store at the referenced location. After the software platform 10 verifies that the provided heaptype matches that of the pointer and that the amount of data to write fits within the allocated structure, the write operation is performed.

As a further detailed example, a method invocation can be performed by passing a message from the software application 12 to the software platform 10 in the following form:

INVOKE(iptr, index, methodtype, N, arg₁, . . . , arg_{N}),

where iptr denotes the called interface instance, index identifies the method, methodtype references the registered type information, N denotes the number of 32-bit method arguments, and arg₁ . . . arg_{N} are the 32-bit argument values.

Upon receiving this message, the software platform 10 takes the following actions: it verifies that the indicated methodtype is indeed valid (i.e., it checks the signature); it deduces the interface UUID from the interface pointer iptr, and verifies that it matches the UUID in the referenced methodtype; and it inspects the methodtype and verifies that each pointer argument is of the indicated type (using the heaptype pointer embedded within the allocated data). If the argument types are correct, the method is invoked. Note that this method embodiment verifies that any pointers actually point to valid instances of the correct type. Further, note that such processing assumes that it is possible to deduce the UUID of the referenced interface from the interface pointer. (This can, for example, be done by including the UUID in a virtual method table.)

The iptr argument references an interface of a component instance and needs to be verified as pointing to an actual instance. Such components are implicitly created on the heap by the software platform 10 in response to the application's method calls, and can be protected by using the same heap allocation and verification mechanisms as previously outlined.

Additional functions may be supported by the software platform 10, e.g., for memory cleanup at application termination or as needed. One example involves the de-allocation of heap data within the software platform's memory space. In one embodiment, de-allocating a heap data instance is performed by passing a message from software application 12 to the software platform 10 in the following form:

HEAP_DEALLOC(p),

where the tag and size parameters are the same as for the HEAP_ALLOC message. Related functions include de-registration of method and heap data type information. De-registering type information previously registered by the software platform 10 for the software application 12 is performed by passing a message from the software application 12 to the software platform 10 in one of the following forms:

DEREGISTER_METHODTYPE(methodtype), and
DEREGISTER_HEAPTYPE(heaptype).

These de-registrations are only necessary to reclaim allocated memory, and can, as noted, be performed upon application termination, garbage collection of the application-side proxy class, or at any other point in time between method invocation and application termination. Note, too, that de-registering type information implies invalidating any associated signature in memory.

With these non-limiting examples in mind, the methods and apparatus proposed herein provide significant advantages over a “traditional” run-time system that embeds type information for all possible data types statically within the given software platform. Embedding all possible type information consumes significant memory (e.g., undesirable amounts of FLASH memory), and further results in a loss of flexibility. That is, with fixed type information embedded in the platform itself, one would have to make careful decisions on which data types and interfaces to support for remote accessing by software applications. Revising those decisions would require re-building the platform.

In contrast, the teachings disclosed herein embed the required type information within the software application 12, as trusted, verifiable type information that is used by the software platform 10 for securing (making safe) the run-time platform accesses made by the software application 12. Although such type information must be transferred to the software platform 10 at run-time, the overhead is limited to exactly the interfaces and data types used by that particular software application 12 (rather than the entire, defined universe of data types and functions). Moreover, additional interfaces can be supported by running the trusted IDL translator 60 (of FIG. 5) without re-building the platform software, or by performing some other revised type information generation, to include the newly added interfaces.

Thus, the teachings presented herein represent a cornerstone component in an overall security architecture for third-party application environments, such as web applications or Widgets running in WEBKIT, JAVA MIDIets, etc. The teachings also may be combined with signing of applications to ensure that sensitive interfaces are not accessed by untrusted applications.

Of course, those skilled in the art will recognize that use as non-limiting. Indeed, the present invention is not limited to the foregoing discussion and accompanying drawings. Instead, the present invention is limited only by the following claims and their legal equivalents.

What is claimed is:

1. In a software platform, a method of securing accesses made to the software platform by a software application comprising:
receiving cryptographically signed type information from the software application, for platform accesses to be made by the software application;
determining whether a cryptographic signature of the received type information is authentic;
if the cryptographic signature is authentic, registering the type information in the software platform; and
permitting platform accesses by the software applications that comport with the registered type information.

2. The method of claim 1, wherein receiving cryptographically signed type information from the software application, for platform accesses to be made by the software application comprises receiving signed data type information and signed method type information.

3. The method of claim 2, wherein determining whether the cryptographic signature of the received type information is authentic includes verifying one or more cryptographic signatures for the data type information and one or more cryptographic signatures for the method type information.

4. The method of claim 2, wherein registering the type information in the software platform comprises registering the data type information and registering the method type information to yield registered data type information and registered method type information, respectively, and wherein registering the method type information includes verifying that each method type being registered links only to registered data types.

5. The method of claim 1, wherein registering the type information in the software platform includes registering data type information and method type information, and wherein permitting platform accesses by the software applications that comport with the registered type information includes allowing platform method invocations and platform memory accesses that match the registered method and data type information and disallowing any platform method invocations and any platform memory accesses that do not match the registered method and data type information.

6. The method of claim 1, wherein determining whether the cryptographic signature of the received type information is authentic comprises verifying the cryptographic signature based on cryptographic key information securely maintained by the software platform, wherein the cryptographic key information comprises one of symmetric secret key pair data or Public Key Infrastructure, PKI, cryptographic key data.

7. The method of claim 1, wherein receiving cryptographically signed type information from the software application, for platform accesses to be made by the software application, comprises receiving one or more heap data type registration messages including cryptographically signed heap data type registration information for use by the software platform in registering heap data types that will be used by the software application, and returning one or more heap data type handles to the software application, for referencing registered heap data types.

8. The method of claim 7, wherein the software platform uses the registered heap data types for verifying instantiations requested by the software application of heap data types and for verifying platform memory accesses by the software application to instances of those heap data types.

9. The method of claim 7, wherein receiving cryptographically signed type information from the software application, for platform accesses to be made by the software application further comprises receiving one or more method type registration messages including cryptographically signed method type registration information for use by the software platform in registering method types to be invoked by the software application, and returning one or more method type handles to the software application, for referencing registered method types.

10. A programmed computer implementing a software platform that secures accesses made to the software platform by a software application, said software platform comprising:
an application program interface, API, layer and an access control layer functionally disposed as an intermediary between the API layer and software applications making use of the API layer;
wherein said access control layer is configured to receive cryptographically signed type information from the software application, for platform accesses to be made by the software application; determine whether a cryptographic signature of the received type information is authentic; register the type information in the software platform if the cryptographic signature is authentic; and permitting platform accesses by the software applications that comport with the registered type information.

11. The programmed computer of claim 10, wherein the access control layer is configured to receive signed data type information and signed method type information as the cryptographically signed type information.

12. The programmed computer of claim 11, wherein the access control layer is configured to determine whether the cryptographic signature of the received type information is authentic by verifying one or more cryptographic signatures received for the data type information and one or more cryptographic signatures received for the method type information.

13. The programmed computer of claim 11, wherein the access control layer is configured to register the type information in the software platform by registering the data type information and registering the method type information to yield registered data type information and registered method type information, respectively, and wherein the access control layer is configured to verify that each method type being registered links only to registered data types.

14. The programmed computer of claim 10, wherein the access control layer is configured to register the type of information in the software platform by registering data type information and method type information, and is configured to permit platform accesses by the software applications that comport with the registered type information by allowing run-time platform method invocations and run-time platform memory accesses that match the registered method and data type information and correspondingly to disallow platform accesses by the software applications that do not comport with the registered type information by disallowing any run-time platform method invocations and any run-time platform memory accesses that do not match the registered method and data type information.

15. The programmed computer of claim 10, wherein the access control layer is configured to determine whether the cryptographic signature of the received type information is authentic by verifying the cryptographic signature based on cryptographic key information securely maintained by the software platform, wherein the cryptographic key information comprises one of symmetric secret key pair data or Public Key Infrastructure, PKI, cryptographic key data.

16. The programmed computer of claim 10, wherein the access control layer is configured to receive as the cryptographically signed type information one or more heap data type registration messages including cryptographically signed heap data type registration information for use by the software platform in registering heap data types that will be used by the software application, and is configured to correspondingly return one or more heap data type handles to the software application, for referencing registered heap data types.

17. The programmed computer of claim 16, wherein the access control layer is configured to use the registered heap data types for verifying instantiations requested by the software application of heap data types and for verifying platform memory accesses by the software application to instances of those heap data types.

18. The programmed computer of claim 16, wherein the access control layer is configured to receive as the cryptographically signed type information one or more method type registration messages including cryptographically signed method type registration information for use by the software platform in registering method types to be invoked by the software application, and is configured to return one or more method type handles to the software application, for referencing registered method types.

19. The programmed computer of claim 10, wherein the programmed computer comprises a processing element in a wireless communication device, and wherein the access control layer of the software platform is configured to provide secured access to the API layer of the software platform for software applications downloaded to or otherwise installed on the wireless communication device.

20. A method of generating a software application intended to gain secure access to a software platform, said method comprising:
generating type information describing software platform data types and methods to be used by the software application;
cryptographically signing the type information using cryptographic key data known to or compatible with decryption processing in the software platform; and
embedding or otherwise bundling the cryptographically signed type information with the software application.

21. The method of claim 20, further comprising configuring the software application to provide the cryptographically signed type information to the software platform for verification by the software platform, to thereby gain access to software platform data types and methods as identified in the cryptographically signed type information.

22. A method for a software application to gain secure access to a software platform comprising:
upon initial execution or loading of the software application, sending cryptographically signed type information to the software platform and receiving registration information for registered data and method types, wherein said cryptographically signed type information identifies those platform data and method types to be used by the software application; and
using the registration information during execution of the software application to generate requests to the platform for data type instantiations, memory accesses, and method invocations.

23. The method of claim 22, wherein the registration information comprises links or pointers to heap space data memory maintained by the software platform.
